(19) United States
(12) Patent Application Publication
(10) Pub. No.: US 2020/0092531 A1
(43) Pub. Date: Mar. 19, 2020

(54) VIDEO IMAGE PRESENTATION AND ENCAPSULATION METHOD AND VIDEO IMAGE PRESENTATION AND ENCAPSULATION APPARATUS

(71) Applicant: HUAWEI TECHNOLOGIES CO., LTD., Shenzhen (CN)

(72) Inventors: Peiyun DI, Shenzhen (CN); Qingpeng XIE, Shenzhen (CN)

(21) Appl. No.: 16/689,517

(22) Filed: Nov. 20, 2019

Related U.S. Application Data
(63) Continuation of application No. PCT/CN2018/088197, filed on May 24, 2018.

(30) Foreign Application Priority Data
May 27, 2017 (CN) 201710387835.0

(51) Int. Cl. H04N 13/178; H04N 13/161

(52) U.S. Cl. CPC H04N 13/178; H04N 13/161

(57) ABSTRACT

A video image presentation and encapsulation method includes: obtaining a bit stream of a first video image; parsing the bit stream, and determining the first video image and first information of the first video image, where the first information is used to indicate whether the first video image is presented as a continuous area; and presenting the first video image based on the first video image and the first information. In this application, the first video image can be better presented based on the first information of the first video image.

### CROSS-REFERENCE TO RELATED APPLICATIONS

This application is a continuation of International Application No. PCT/CN2018/088197, filed on May 24, 2018, which claims priority to Chinese Patent Application No. 201710387835.0, filed on May 27, 2017. The disclosures of the aforementioned applications are hereby incorporated by reference in their entireties.

### TECHNICAL FIELD

This application relates to the field of video image processing, and more specifically, to a video image presentation and encapsulation method and a video image presentation and encapsulation apparatus.

### BACKGROUND

The rise of virtual reality (VR) brings new visual experience to people, and brings new technical challenges as well. When a VR video image is encoded, the VR video image is usually divided into a plurality of independent video images, and then each video image is encoded to obtain bit streams of different video images. Because different video images may include different image information, how to present a video image remains a problem to be resolved.

### SUMMARY

This application provides a video image presentation and encapsulation method, and a video image presentation and encapsulation apparatus, so as to improve a display effect.

According to a first aspect, a video image presentation method is provided, where the method includes: obtaining a bit stream of a first video image;

parsing the bit stream, and determining the first video image and first information of the first video image, where the first information is used to indicate whether the first video image is presented as a continuous area; and presenting the first video image based on the first information.

It should be understood that the first video image may be a part of an original complete video image, or the first video image is a video sub-image obtained by dividing the original complete video image, and the video sub-image may be directly referred to as a sub-image.

When a video image is presented, it is considered whether the video image is a continuous area in a finally displayed image, thereby better presenting the video image and improving a display effect.

Specifically, when a video image is a continuous area in the finally displayed image, the video image may be directly presented. When the video image is not a continuous area in the finally displayed image, the video image may be spliced with another video image and then the spliced image is presented.

With reference to the first aspect, in some implementations of the first aspect, the presenting the first video image based on the first information includes: presenting the first video image when the first information indicates that the first video image is presented as a continuous area.

It should be understood that when the first video image is presented as a continuous area, the first video image is finally mapped to a spherical surface to display continuous image content.

When it is determined that the first video image can be presented as a continuous area, the first video image is presented, so that continuous image content can be displayed, and a display effect is relatively good.

With reference to the first aspect, in some implementations of the first aspect, at least a part of the first video image is adjacent to a second video image when the images are presented, and the presenting a sub-image based on the first information includes: when the first information indicates that the first video image is not presented as a continuous area, splicing the first video image and the second video image based on a location relationship at which the images are presented and presenting the spliced video image.

It should be understood that when the first video image cannot be presented as a continuous area, if the first video image is mapped to a spherical surface for display, discontinuous image content may be displayed on the spherical surface.

When the first video image cannot be presented as a continuous area, the second video image adjacent to the content of the first video image needs to be spliced with the first video image based on a location relationship at which the images are presented and then the spliced image is presented, so as to ensure that a continuous image is displayed, thereby improving a display effect.

According to a second aspect, a video image presentation method is provided, where the method includes: obtaining a bit stream of a first video image;

parsing the bit stream, and determining the first video image and second information of the first video image, where the second information is used to indicate an image type of the first video image, the image type of the first video image includes a spherical image, a two-dimensional plane image not processed by using a first operation, or a two-dimensional plane image processed by using the first operation, and the first operation is at least one of segmentation, sampling, reversal, rotation, mirroring, or splicing; and presenting the first video image based on the second information.

It should be understood that the first video image may be a part of an original complete video image, or the first video image is a video sub-image obtained by dividing the original complete video image, and the video sub-image may be directly referred to as a sub-image.

When an image is presented, a video image and an image type of the video image may be obtained from a bit stream of the video image, and a subsequent operation can be initialized in advance based on the image type of the video image, thereby reducing a delay of presenting the video image and improving display efficiency.

Specifically, when a video image is being parsed, an image type of the video image may be obtained, and subsequent operation processing that needs to be performed on the video image can be determined as earliest as possible based on the image type of the video image. Then, the operation processing may be initialized first, thereby reducing a delay of presenting the video image and improving display efficiency, compared with the prior art in which these operations can be started only after bit streams of all videos are parsed.

With reference to the second aspect, in some implementations of the second aspect, the presenting the first video image based on the second information includes: presenting the first video image in a spherical display manner when the second information indicates that the first video image is a spherical image.

With reference to the second aspect, in some implementations of the second aspect, the presenting the first video image based on the second information includes: when the second information indicates that the first video image is a two-dimensional plane image not processed by using the first operation, mapping the first video image as a spherical image; and presenting the spherical image in a spherical display manner.

When the first video image is a first-type two-dimensional plane image, the first video image needs to be mapped as a spherical image before being displayed on a spherical surface. Otherwise, if the image type of the first video image is unknown, a display error may occur when the first video image is directly presented. Therefore, the image type of the first video image may be determined based on the second information, so that the first video image is correctly displayed.

With reference to the second aspect, in some implementations of the second aspect, the presenting the first video image based on the second information includes: when the second information indicates that the first video image is a two-dimensional plane image processed by using the first operation, performing a second operation on the first video image to obtain a first video image processed by using the second operation, where the second operation is an inverse operation of the first operation; mapping the first video image processed by using the second operation as a spherical image; and presenting the spherical image in a spherical display manner.

When the first video image is a second-type two-dimensional plane image, the second operation needs to be performed on the first video image, and then the first video image processed by using the second operation is mapped as a spherical image before being displayed on a spherical surface. Otherwise, a display error may also occur if the first video image is directly mapped as a spherical image and the spherical image is presented in a spherical display manner. Therefore, the image type of the first video image may be determined based on the second information, so that the first video image is correctly displayed.

According to a third aspect, a video image encapsulation method is provided, where the method includes: determining first information of a first video image, where the first information is used to indicate whether the first video image is a continuous area in a to-be-encoded image corresponding to the first video image; encoding the first video image and the first information to obtain a bit stream of the first video image; and encapsulating the bit stream to obtain an image track of the first video image.

It should be understood that the first video image may be a part of an original complete video image, or the first video image is a video sub-image obtained by dividing the original complete video image, and the video sub-image may be directly referred to as a sub-image.

Information indicating whether a video image is a continuous area in the to-be-encoded image is also encoded into a bit stream of the video image, so that when the video image is presented, it can be considered whether the video image is a continuous area in a to-be-displayed image, thereby better presenting the video image and improving a display effect.

For example, when the video image is a continuous area in a finally displayed image, the video image may be directly presented. When the video image is not a continuous area in the finally displayed image, the video image may be spliced with another video image and then the spliced image is displayed.

According to a fourth aspect, a video image encoding method is provided, where the method includes: determining second information of a first video image, where the second information is used to indicate an image type of the first video image, the image type includes a spherical image, a two-dimensional plane image not processed by using a first operation, or a two-dimensional plane image processed by using the first operation, and the first operation is at least one of segmentation, sampling, reversal, rotation, mirroring, or splicing; encoding the first video image and the second information to obtain a bit stream of the first video image; and encapsulating the bit stream to obtain an image track of the first video image.

It should be understood that the first video image may be a part of an original complete video image, or the first video image is a video sub-image obtained by dividing the original complete video image, and the video sub-image may be directly referred to as a sub-image.

Image type information of a video image is also encoded into a bit stream of the video image, so that the video image and the image type of the video image may be obtained from the bit stream of the video image when the image is presented, and a subsequent operation can be initialized in advance based on the image type of the video image, thereby reducing a delay of presenting the video image and improving display efficiency.

Specifically, when a video presentation device is parsing a video image, an image type of the video image may be obtained, and subsequent operation processing that needs to be performed on the video image can be determined as earliest as possible based on the image type of the video image. Then, the operation processing may be initialized first, thereby reducing a delay of presenting the video image and improving display efficiency, compared with the prior art in which these operations can be started only after bit streams of all videos are parsed.

According to a fifth aspect, a video image presentation apparatus is provided, where the apparatus includes a module configured to perform the method in the first aspect or various implementations of the first aspect.

According to a sixth aspect, a video image presentation apparatus is provided, where the apparatus includes a module configured to perform the method in the second aspect or various implementations of the second aspect.

According to a seventh aspect, a video image encapsulation apparatus is provided, where the apparatus includes a module configured to perform the method in the third aspect or various implementations of the third aspect.

According to an eighth aspect, a video image encapsulation apparatus is provided, where the apparatus includes a module configured to perform the method in the fourth aspect or various implementations of the fourth aspect.

According to a ninth aspect, a video image presentation apparatus is provided, where the apparatus includes a storage medium and a central processing unit, the storage medium stores a computer executable program, and the central processing unit is connected to the storage medium, and executes the computer executable program to implement the method in the first aspect or various implementations of the first aspect.

According to a tenth aspect, a video image presentation apparatus is provided, where the apparatus includes a storage medium and a central processing unit, the storage medium stores a computer executable program, and the central processing unit is connected to the storage medium, and executes the computer executable program to implement the method in the second aspect or various implementations of the second aspect.

According to an eleventh aspect, a video image encapsulation apparatus is provided, where the apparatus includes a storage medium and a central processing unit, the storage medium stores a computer executable program, and the central processing unit is connected to the storage medium, and executes the computer executable program to implement the method in the third aspect or various implementations of the third aspect.

According to a twelfth aspect, a video image encapsulation apparatus is provided, where the apparatus includes a storage medium and a central processing unit, the storage medium stores a computer executable program, and the central processing unit is connected to the storage medium, and executes the computer executable program to implement the method in the fourth aspect or various implementations of the fourth aspect.

It should be understood that, in the ninth aspect to the twelfth aspect, the storage medium may be a non-volatile storage medium.

According to a thirteenth aspect, a computer readable medium is provided, where the computer readable medium stores program code to be executed by a device, and the program code includes an instruction used to perform the method in the first aspect or various implementations of the first aspect.

According to a fourteenth aspect, a computer readable medium is provided, where the computer readable medium stores program code to be executed by a device, and the program code includes an instruction used to perform the method in the second aspect or various implementations of the second aspect.

According to a fifteenth aspect, a computer readable medium is provided, where the computer readable medium stores program code to be executed by a device, and the program code includes an instruction used to perform the method in the third aspect or various implementations of the third aspect.

According to a sixteenth aspect, a computer readable medium is provided, where the computer readable medium stores program code to be executed by a device, and the program code includes an instruction used to perform the method in the fourth aspect or various implementations of the fourth aspect.

It should be understood that the technical solutions provided in the fifth aspect to the sixteenth aspect of the present application are respectively consistent with the technical solutions and technical means provided in the first aspect to the fourth aspect, and beneficial effects of the technologies are similar. Details are not described again.

### DESCRIPTION OF DRAWINGS

FIG. 1 is a schematic flowchart of a video image presentation method according to an embodiment of this application;

FIG. 2 is a schematic diagram of a spherical image, a first-type two-dimensional plane image, and a second-type two-dimensional image;

FIG. 3 is a schematic diagram of a video image;

FIG. 4 is a schematic diagram of a location of a video image in a two-dimensional plane image;

FIG. 5 is a schematic diagram of a location of a video image on a spherical surface;

FIG. 6 is a schematic flowchart of a video image presentation method according to an embodiment of this application;

FIG. 7 is a schematic flowchart of a video image encapsulation method according to an embodiment of this application;

FIG. 8 is a schematic flowchart of a video image encapsulation method according to an embodiment of this application;

FIG. 9 is a schematic flowchart of generating a bit stream of a sub-image;

FIG. 10 is a schematic flowchart of parsing a bit stream of a sub-image;

FIG. 11 is a schematic block diagram of a video image presentation apparatus according to an embodiment of this application;

FIG. 12 is a schematic block diagram of a video image presentation apparatus according to an embodiment of this application;

FIG. 13 is a schematic block diagram of a video image encapsulation apparatus according to an embodiment of this application;

FIG. 14 is a schematic block diagram of a video image encapsulation apparatus according to an embodiment of this application;

FIG. 15 is a schematic block diagram of a codec apparatus according to an embodiment of this application;

FIG. 16 is a schematic diagram of a codec apparatus according to an embodiment of this application; and

FIG. 17 is a schematic block diagram of a video codec system according to an embodiment of this application.

### DESCRIPTION OF EMBODIMENTS

The following describes technical solutions of this application with reference to accompanying drawings.

FIG. 1 is a schematic flowchart of a video image presentation method according to an embodiment of this application. A method 100 in FIG. 1 includes the following steps:

110. Obtain a bit stream of a first video image.

The foregoing first video image may be a part of an original complete video image (the complete video image may also be referred to as an original video image, an original image, or an initial image), or the first video image is a video sub-image obtained by dividing the original complete video image, and the video sub-image may also be directly referred to as a sub-image.

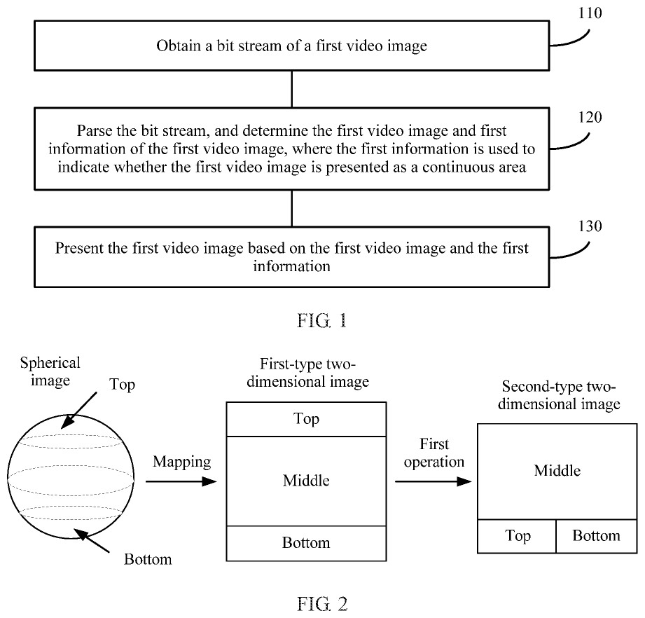

It is assumed that the first video image is obtained by dividing the original video image, and the first video image is a sub-image of the original image. The original image may be a spherical image shown in FIG. 2, and the spherical image may be an image that has a 360-degree visual angle. The original image may further be a first-type two-dimensional plane image shown in FIG. 2. The first-type two-dimensional plane image is obtained by mapping the spherical image to a plane, and the first-type two-dimensional plane image may be either a topographic map or a plane image obtained by mapping the spherical image to a hexahedron and then unfolding the six surfaces of the hexahedron. In addition, the original image may further be a second-type two-dimensional image shown in FIG. 2. The second-type two-dimensional image is a plane image obtained by performing a specific operation (for example, segmentation, sampling, reversal, rotation, mirroring, or splicing) on the first-type two-dimensional image. In FIG. 2, a top area and a bottom area of the first-type two-dimensional image are compressed and spliced, and then arranged below a middle area to obtain a second-type two-dimensional plane image.

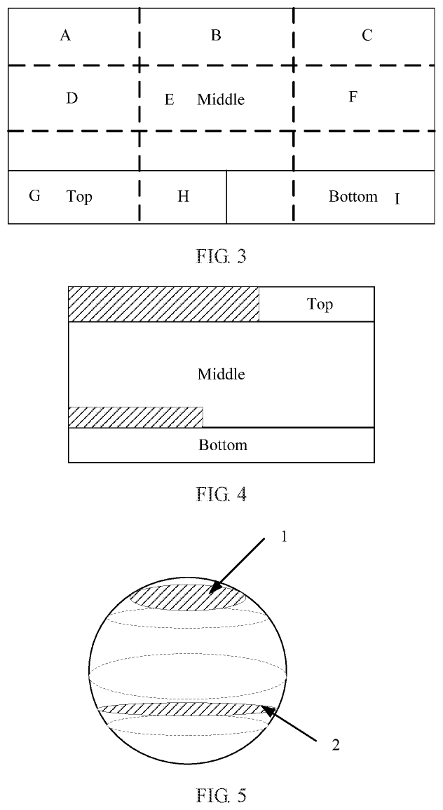

For example, as shown in FIG. 3, when the original image is a second-type two-dimensional image, the original image may be divided into nine sub-images (four dashed lines divide the two-dimensional plane image into nine areas, and each area corresponds to one sub-image), namely, sub-images A, B, C, D, E, F, G, H, and I. The foregoing first video image may be any one of the nine sub-images.

The original image is divided into a plurality of sub-images, thereby facilitating video image encoding.

120. Parse the bit stream, and determine the first video image and first information of the first video image.

The foregoing first information may be used to indicate whether the first video image is presented as a continuous area.

The bit stream of the first video image may be a bit stream generated when an encoding end encodes the first video image. The bit stream may be parsed to obtain not only the first video image but also the first information of the first video image.

When the foregoing first video image is a sub-image A in FIG. 3, the first information of the sub-image A is specifically used to indicate that the sub-image A is presented as a continuous area, because the sub-image A includes an image of a continuous area in the middle area of the first-type two-dimensional image. Similarly, when the foregoing first video image is a sub-image B to a sub-image F in FIG. 3, the first information of the first video image also indicates that the first video image can be presented as a continuous area.

When the first video image is a sub-image G in FIG. 3, the first information of the sub-image is specifically used to indicate that the sub-image is not a continuous area in a finally displayed image, because the sub-image G includes images of the middle area and the top area of the first-type two-dimensional image, and the images of the two areas are not adjacent to each other. Therefore, when the sub-image is the sub-image G̨ the sub-image is a discontinuous area in the finally displayed image. Likewise, when the sub-image is a sub-image H and a sub-image I in FIG. 3, the first information of the sub-image also indicates that the sub-image is not a continuous area in the finally displayed image.

130. Present the first video image based on the first information.

It should be understood that the foregoing method 100 may be performed by a video presentation device, and the video presentation device may also be a decoding end device, a decoder, or a device having a decoding function.

In this application, when a video image is presented, it is considered whether the video image is a continuous area in the finally displayed image, thereby better presenting the video image and improving a display effect.

Specifically, when a video image is a continuous area in the finally displayed image, the video image may be directly presented. When the video image is not a continuous area in the finally displayed image, the video image may be spliced with another video image and then the spliced image is presented.

When the first video image is presented based on the first information, the following two cases may be specifically included:

Case 1: The first video image may be presented as a continuous area

In this case, because the first video image is finally presented as a continuous area, image content of the first video image may be directly displayed.

The image content of the first video image is presented only when it is determined that the first video image can be presented as a continuous area. This can ensure that displayed image content is continuous, and can ensure a specific display effect.

Specifically, when the first video image can be presented as a continuous area, the first video image is finally mapped to a spherical surface for displaying continuous image content. When the first video image is not presented as a continuous area, if the first video image is still directly mapped to the spherical surface for display, discontinuous image content may be displayed on the spherical surface, thereby affecting visual experience.

Case 2: The first video image is not presented as a continuous area

In this case, if the first video image is directly presented to the spherical surface for display, the image content may be discontinuous on the spherical surface (for example, two pieces of completely irrelevant image content may be displayed).

Therefore, in this case, a second video image may be obtained based on a bit stream of the second video image, where the second video image is a video image adjacent to at least a part (image content) of the first video image when the second video image is presented, and then the first video image and the second video image are spliced based on a location relationship at which the images are presented and then the spliced image is presented.

It should be understood that the location relationship between the first video image and the second video image when the images are presented may be directly obtained by parsing the bit stream of the entire video, or may be determined based on the location information of the first video image and the second video image respectively obtained from the bit streams of the first video image and the second video image.

When the first video image cannot be presented as a continuous area, the second video image adjacent to the content of the first video image needs to be spliced with the first video image based on a location relationship at which the images are presented and then the spliced image is presented, so as to ensure that a continuous image is displayed, thereby improving a display effect.

For example, when the foregoing first video image is a sub-image G in FIG. 3, locations of the sub-image G on a first-type two-dimensional plane image and a spherical image are respectively shown in FIG. 4 and FIG. 5. Specifically, the locations of the sub-image G on the first-type two-dimensional plane image in FIG. 4 are respectively on the left of the top area and on the lower left corner of the middle area (shadow areas in FIG. 4). The locations of the sub-image G on the spherical image in FIG. 5 are shadow areas 1 and 2. This shows that the sub-image G on the first-type two-dimensional plane image and the sub-image G on the spherical image are two discontinuous areas. Therefore, if the sub-image is directly presented, two pieces of discontinuous image content are displayed and a display effect is not good.

There are many implementations for the foregoing first information. For example, the first information may be described in new syntax extended in the Track Group Type Box of the first video image. Specifically, syntax in the SubPicture Composition Box may be used to describe the first information.

Specifically, for the first information, a value of content continuity may be used to indicate whether the first video image is presented as a continuous area. Specific syntax is as follows:

```
    aligned(8) class SubPictureCompositionBox extends
TrackGroupTypeBox(‘spco’)
    {
    ...
    unsigned int(8) content_continuity;
    ...
    }
```

When content_continuity=0, the first video image is presented as a continuous area.

When content_continuity=1, the first video image is not presented as a continuous area.

It should be understood that the foregoing description is only a specific case in which different values of content_continuity indicate whether the first video image is presented as a continuous area. In practice, another value of content_continuity may be further used to separately indicate whether the first video image is presented as a continuous area.

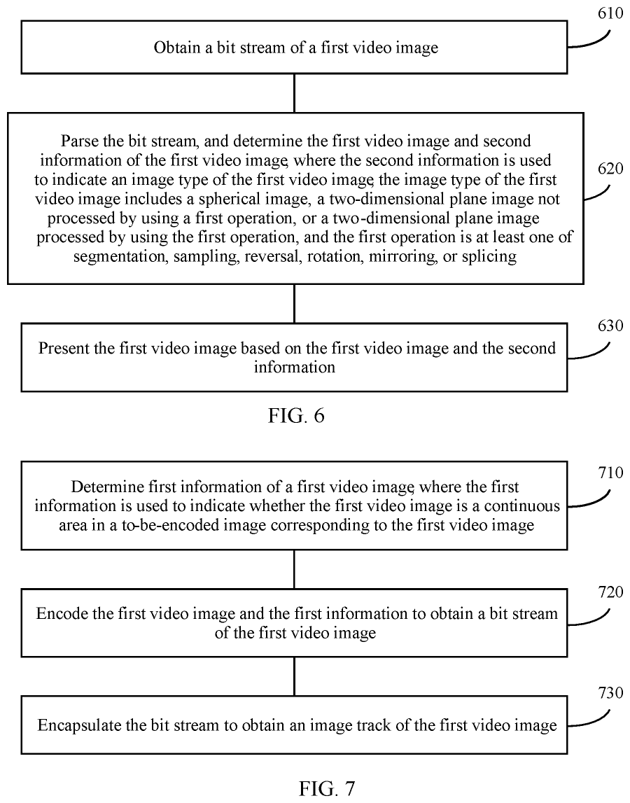

FIG. 6 is a schematic flowchart of a video image decoding method according to an embodiment of this application. A method 600 in FIG. 6 includes the following steps:

610. Obtain a bit stream of a first video image.

The foregoing first video image may be a part of an original complete video image (the complete video image may also be referred to as an original video image, an original image, or an initial image), or the first video image is a video sub-image obtained by dividing the original complete video image, and the video sub-image may also be directly referred to as a sub-image.

When the first video image is a sub-image obtained by dividing the original video image, the original video image may be a spherical image, a first-type two-dimensional plane image, or a second-type two-dimensional plane image shown in FIG. 2. The spherical image may be an image that has a 360-degree visual angle, the first-type two-dimensional plane image may be a plane image obtained by mapping the spherical image to a plane, and the first-type two-dimensional plane image may be either a topographic map or a plane image obtained by mapping the spherical image to a hexahedron and then unfolding the six surfaces of the hexahedron. A second-type two-dimensional image may be a plane image obtained by performing a specific operation (for example, segmentation, sampling, reversal, rotation, mirroring, or splicing) on the first-type two-dimensional image. Specifically, in FIG. 2, a top area and a bottom area of the first-type two-dimensional image are compressed and spliced, and then arranged below a middle area to obtain a second-type two-dimensional plane image.

For example, as shown in FIG. 3, when the original video image of the first video image is a second-type two-dimensional image, the original video image may be divided into nine sub-images, and the first video image may be any one of the nine sub-images.

620. Parse the bit stream, and determine the first video image and second information of the first video image, where the second information is used to indicate an image type of the first video image, and the image type of the first video image includes a spherical image, a two-dimensional plane image not processed by using the first operation, or a two-dimensional plane image processed by using the first operation.

The foregoing first operation may be at least one of segmentation, sampling, reversal, rotation, mirroring, or splicing.

It should be understood that the image type of the first video image is the same as the image type of the original video image of the first video image. For example, if the original video image is a first-type two-dimensional plane image, the image type of the first video image obtained by dividing the original video image is also a first-type two-dimensional plane image.

The foregoing two-dimensional plane image not processed by using the first operation may be a first-type two-dimensional plane image in FIG. 2. Such a two-dimensional plane image is obtained by directly mapping a spherical image to a plane, and a first operation is not performed after the two-dimensional plane image is mapped to the plane.

The foregoing two-dimensional plane image processed by using the first operation may be a second-type two-dimensional plane image in FIG. 2. Such a two-dimensional plane image is a plane image obtained by directly mapping a spherical image to a plane to obtain a first-type two-dimensional plane image, and then performing an operation such as segmentation, sampling, reversal, or splicing on the first-type two-dimensional plane image.

In addition, the foregoing first operation may be referred to as packing, and a second operation may be referred to as reverse packing.

630. Present the first video image based on the second information.

When an image is presented, a video image and an image type of the video image may be obtained from a bit stream of the video image, and a subsequent operation can be initialized in advance based on the image type of the video image, thereby reducing a delay of presenting the video image and improving display efficiency.

Specifically, when a video image is being parsed, an image type of the video image may be obtained, and subsequent operation processing that needs to be performed on the video image can be determined as earliest as possible based on the image type of the video image. Then, the operation processing may be initialized first, thereby reducing a delay of presenting the video image and improving display efficiency, compared with the prior art in which these operations can be started only after bit streams of all videos are parsed.

It should be understood that the foregoing method 600 may be performed by a video presentation device, and the video presentation device may also be a decoding end device, a decoder, or a device having a decoding function.

A process of presenting the first video image varies with the image type of the first video image. The following three cases may be specifically included:

(1) The first video image is a spherical image.

When the first video image is a spherical image, the first video image may be directly presented on a spherical surface for display, that is, the first video image may be presented in a spherical display manner. Specifically, when the first video image is a spherical image, the first video image is a part (or all) of the original video image (the original video image is also a spherical image). In this case, the first video image is directly presented to a corresponding location on a spherical surface for direct display based on the location information of the first video image on the spherical surface.

(2) The first video image is a two-dimensional plane image not processed by using the first operation.

In this case, the first video image may be a first-type two-dimensional plane image shown in FIG. 2. When an image is presented, the first video image is first mapped as a spherical image, and then the spherical image is presented in a spherical display manner.

When the first video image is a first-type two-dimensional plane image, the first video image needs to be mapped as a spherical image before being displayed on a spherical surface. Otherwise, if the image type of the first video image is unknown, a display error may occur when the first video image is directly presented. Therefore, the image type of the first video image may be determined based on the second information, so that the first video image is correctly displayed.

(3) The first video image is a two-dimensional plane image processed by using the first operation.

In this case, the first video image may be a second-type two-dimensional plane image shown in FIG. 2. To present a sub-image of the first video image, a second operation needs to be performed on the first video image to obtain a first video image processed by using the second operation, where the second operation is an inverse operation (or referred to as an opposite operation or a reverse operation) of the first operation. Then, the first video image processed by using the second operation is mapped to a spherical surface to obtain a spherical image, and the spherical image is presented in a spherical display manner.

When the first video image is a second-type two-dimensional plane image, a second operation needs to be performed on the first video image, and then a first video image processed by using the second operation is mapped as a spherical image before being displayed on a spherical surface. Otherwise, a display error may also occur if the first video image is directly mapped as a spherical image and the spherical image is presented in a spherical display manner. Therefore, the image type of the first video image may be determined based on the second information, so that the first video image is correctly displayed.

It should be understood that when the foregoing first operation is reversal, the second operation is also reversal. After the second operation, the video image may be restored to a state before the first operation. In other words, the second operation is a restoration operation of the first operation, and an image processed by using the first operation can be restored, by using the second operation, to a state before the first operation processing.

When the first video image is a second-type two-dimensional plane image shown in FIG. 2, images of the top area and the bottom area may be magnified, and the magnified images of the top area and the bottom area are respectively moved to the upper and lower parts of the middle area to finally obtain the first-type two-dimensional plane image shown in FIG. 2.

There are many implementations for the foregoing second information. For example, the second information may be described in new syntax extended in the Track Group Type Box of the first video image. Specifically, syntax in the SubPicture Composition Box may be used to describe the second information.

Specifically, for the second information, a value of fullpictureType may be used to indicate an image type of a video image. Specific syntax is as follows:

```
    aligned(8) class SubPictureCompositionBox extends
TrackGroupTypeBox(‘spco’)
    {
    ...
    unsigned int(8) fullpictureType;
    ...
    }
```

When fullpictureType=0, the first video image is a spherical image.

When fullpictureType=1, the first video image is a two-dimensional plane image, and the first video image is not processed by using the first operation.

When fullpictureType=2, the first video image is a two-dimensional plane image, and the first video image is processed by using the first operation.

It should be understood that the foregoing description is only a specific case in which different values of fullpictureType are used to indicate the image type of the first video image. In practice, another value of fullpictureType may be further used to indicate the image type of the first video image.

Optionally, the second information may further include two pieces of sub-information, first sub-information and second sub-information, where the first sub-information is used to indicate whether the first video image is a spherical image or a two-dimensional plane image. When the first sub-information indicates that the video image is a two-dimensional plane image, the second sub-information indicates whether the video image is processed by using the first operation.

In other words, when the first video image is a spherical image, the second information includes only the first sub-information. When the first video image is a two-dimensional plane image, the second information includes both the first sub-information and the second sub-information, where the first sub-information indicates that the first video image is a two-dimensional plane image, and the second sub-information indicates whether the first video image is processed by using the first operation.

For the first sub-information in the second information, a value of fullpictureType may also be used to indicate the image type of the first video image. Specific syntax is as follows:

```
    aligned(8) class SubPictureCompositionBox extends
TrackGroupTypeBox(‘spco’)
    {
    ...
    unsigned int(8) fullpictureType;
    ...
    }
```

When fullpictureType=0, the first video image is a spherical image.

When fullpictureType=1, the first video image is a two-dimensional plane image.

It should be understood that the foregoing description is only a specific case in which different values of fullpictureType are used to indicate the image type of the first video image. In practice, another value of fullpictureType may be further used to indicate the image type of the first video image.

The second sub-information in the second information may also be represented by using a statement similar to the first sub-information. Specifically, a value of packing may be used to indicate the image type of the first video image.

Specific syntax is as follows:

```
    aligned(8) class SubPictureCompositionBox extends
TrackGroupTypeBox(‘spco’)
    {
    ...
    unsigned int(8) packing;
    ...
    }
```

When packing=0, the first video image is not processed by using the first operation.

When packing=1, the first video image is processed by using the first operation.

It should be understood that the foregoing description is only a specific case in which different values of packing are used to indicate the image type of the first video image (whether the video image is processed by using the first operation). In practice, another value of packing may be further used to indicate the image type of the first video image.

Optionally, the method 100 or the method 600 further includes: determining third information of the first video image based on a bit stream of the first video image, where the third information is used to indicate whether the first video image is a full-picture image; and presenting the first video image based on the third information.

It should be understood that the full-picture image herein may be a to-be-displayed complete image, and the first video image may be the entire to-be-displayed complete image or only a part of the to-be-displayed complete image.

Specifically, when the third information indicates that the first video image is a full-picture image, after parsing the third information, a decoding end or a video presentation apparatus may determine that the first video image includes the entire image instead of a part of the image, and image content at any location in the entire image may be presented without using another video image. When the third information indicates that the first video image is an entire image, after parsing the third information, the decoding end or the video presentation apparatus further needs to parse location information and resolution information of the first video image to determine the location of the first video image in the entire image, and then present the first video image.

For the foregoing third information, a value of fullpicture may also be used to indicate whether the first video image is a full-picture image. Specific syntax is as follows:

```
    aligned(8) class SubPictureCompositionBox extends
TrackGroupTypeBox(‘spco’)
    {
    ...
    unsigned int(8) fullpicture;
    ...
    }
```

When fullpicture=0, the first video image is a full-picture image.

When fullpicture=1, the first video image is a part of the full-picture image.

It should be understood that the foregoing description is only a specific case in which different values of fullpicture are used to indicate whether the first video image is a full-picture image. In practice, another value of fullpicture may be further used to indicate whether the first video image is a full-picture image.

It should be understood that in this application, at least one of first information, second information, and third information may be obtained by parsing a bit stream of a sub-image of the first video image, and the first video image may be presented based on one or more of the three types of information when the parsed first video image is presented.

Therefore, solutions for presenting the first video image based on one or more of the first information, the second information, and the third information are within the protection scope of this application.

Optionally, the presenting the parsed first video image based on the first information and the second information includes: determining, based on the first information, whether the first video image is presented as a continuous area; determining an image type of the first video image based on the second information; and presenting image content of the first video image based on whether the first video image is presented as a continuous area and based on the image type of the first video image.

Optionally, in an embodiment, the presenting image content of the first video image based on whether the first video image is presented as a continuous area and based on the image type of the first video image includes: (directly) presenting the first video image in a spherical display manner when the first video image is presented as a continuous area and the first video image is a spherical image.

Optionally, in an embodiment, the presenting image content of the first video image based on whether the first video image is presented as a continuous area and based on the image type of the first video image includes: mapping the first video image as a spherical image when the first video image is presented as a continuous area and the first video image is a two-dimensional plane image not processed by using the first operation; and presenting the spherical image in a spherical display manner.

Optionally, in an embodiment, the presenting image content of the first video image based on whether the first video image is presented as a continuous area and based on the image type of the first video image includes: performing a second operation on the first video image when the first video image is presented as a continuous area, and the first video image is a two-dimensional plane image processed by using the first operation, to obtain a first video image processed by using the second operation, where the second operation is an inverse operation or a reverse operation of the first operation; mapping the first video image processed by using the second operation as a spherical image; and presenting the spherical image in a spherical display manner.

It should be understood that, in this embodiment of this application, to present the image content of the first video image, location information of the first video image in the entire video image may further be used.

There are many implementations for the location information of the first video image. For example, the location information of the first video image may be described in new syntax extended in a Track Group Type Box of the first video image. Specifically, syntax in a SubPicture Composition Box may be used to describe the location information of the first video image.

The syntax for describing the location information of the first video image is specifically as follows:

```
    aligned(8) class SubPictureCompositionBox extends
TrackGroupTypeBox(‘spco’)
    {
      ...
      unsigned int(16) track_x;
      unsigned int(16) track_y;
      unsigned int(16) track_width;
      unsigned int(16) track_height;
      unsigned int(16) composition_width;
      unsigned int(16) composition_height;
      ...
    }
```

track_x indicates a horizontal location of the upper left corner of the first video image in an entire video image (or referred to as an original video image), with a value of a natural number, and a range [0, composition_width−1];

track_y indicates a vertical location of the upper left corner of the first video image in the entire video image, with a value of a natural number, and a range [0, composition_height−1];

track_width indicates a width of the first video image, with a value of an integer, and a range [1, composition_width−track_x];

track_height indicates a height of the first video image, with a value of an integer, and a range [1, composition_height−track_y];

composition_width indicates the width of the first video image; and

composition_height indicates the height of the first video image.

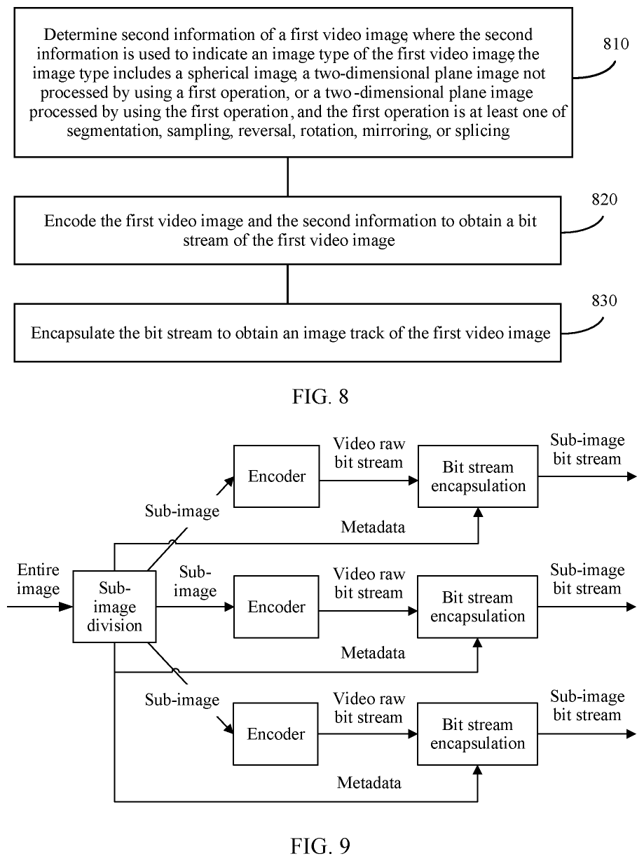

The foregoing describes in detail the video image presentation method in this embodiment of this application with reference to FIG. 1 to FIG. 6. The following describes a video image encapsulation method in this embodiment of this application from a perspective of video image encapsulation with reference to FIG. 7 and FIG. 8. It should be understood that the video image encapsulation methods shown in FIG. 7 and FIG. 8 are respectively corresponding to the foregoing methods 100 and 600. For brevity, repeated descriptions are appropriately omitted below.

FIG. 7 is a schematic flowchart of a video image encapsulation method according to an embodiment of this application. A method 700 in FIG. 7 includes the following steps:

710. Determine first information of a first video image, where the first information is used to indicate whether the first video image is a continuous area in a to-be-encoded image corresponding to the first video image.

720. Encode the first video image and the first information to obtain a bit stream of the first video image.

730. Encapsulate the bit stream to obtain an image track of the first video image.

The first video image may be a part of an original complete video image, or the first video image is a video sub-image obtained by dividing the original complete video image, and the video sub-image may be directly referred to as a sub-image.

Information indicating whether a video image is a continuous area in the to-be-encoded image is also encoded into a bit stream of the video image, so that when the video image is presented, it can be considered whether the video image is a continuous area in a to-be-displayed image, thereby better presenting the video image and improving a display effect.

For example, when the video image is a continuous area in a finally displayed image, the video image may be directly presented. When the video image is not a continuous area in the finally displayed image, the video image may be spliced with another video image and then the spliced image is displayed.

FIG. 8 is a schematic flowchart of a video image encapsulation method according to an embodiment of this application. A method 800 in FIG. 8 includes the following steps:

810. An image type includes a spherical image, a two-dimensional plane image not processed by using a first operation, or a two-dimensional plane image processed by using the first operation, where the first operation is at least one of segmentation, sampling, reversal, rotation, mirroring, or splicing.

820. Encode a first video image and second information to obtain a bit stream of the first video image.

830. Encapsulate the bit stream to obtain an image track of the first video image.

The first video image may be a part of an original complete video image, or the first video image is a video sub-image obtained by dividing the original complete video image, and the video sub-image may be directly referred to as a sub-image.

Image type information of a video image is also encoded into a bit stream of the video image, so that the video image and the image type of the video image may be obtained from the bit stream of the video image when the image is presented, and a subsequent operation can be initialized in advance based on the image type of the video image, thereby reducing a delay of presenting the video image and improving display efficiency.

Specifically, when a video presentation device is parsing a video image, an image type of the video image may be obtained, and subsequent operation processing that needs to be performed on the video image can be determined as earliest as possible based on the image type of the video image. Then, the operation processing may be initialized first, thereby reducing a delay of presenting the video image and improving display efficiency, compared with the prior art in which these operations can be started only after bit streams of all videos are parsed.

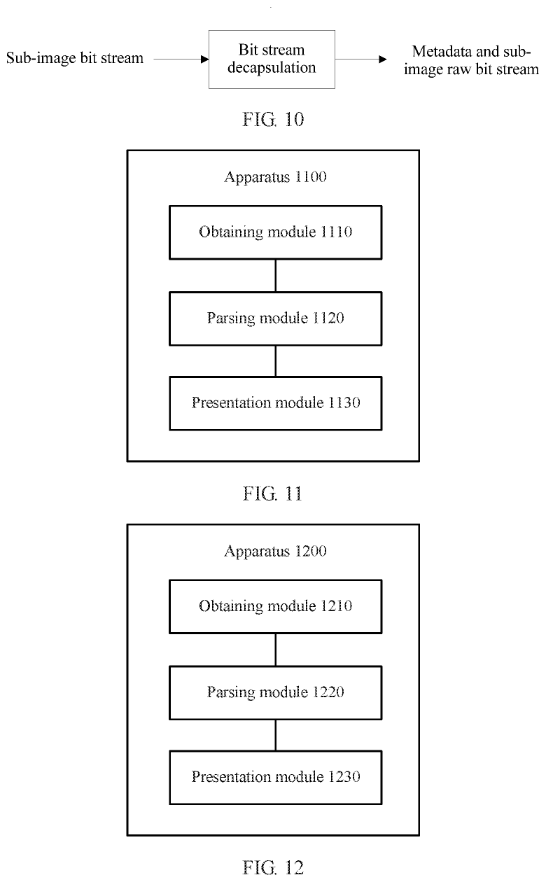

To better understand the video image presentation method and the video image encapsulation method in this embodiment of this application, the following briefly describes, with reference to FIG. 9 and FIG. 10, a bit stream generation and parsing process of a sub-image (equivalent to the foregoing first video image) in a video image processing process.

FIG. 9 is a schematic flowchart of generating a bit stream of a sub-image. In FIG. 9, a sub-image division module divides an entire input image into a plurality of sub-images, determines metadata of each sub-image, and outputs the sub-images; an encoder encodes each input sub-image to generate a video raw bit stream; and a bit stream encapsulation module encapsulates the input video raw bit stream and the metadata into a sub-image bit stream.

The video raw bit stream data is a bit stream in compliance with an ITU-T H.264 or an ITU-T H.265 specification. The metadata of the sub-image may include at least one of the first information, the second information, and the third information described above. The metadata may be obtained from the sub-image division module, or may be obtained from a preset condition for division.

FIG. 10 is a schematic flowchart of parsing a bit stream of a sub-image. In FIG. 10, a bit stream decapsulation module obtains bit stream data of a sub-image, and parses the bit stream data to obtain video metadata and video raw bit stream data. Then, image information of the sub-image may be obtained from the video metadata, and then the sub-image is presented based on the image information of the sub-image and the sub-image obtained by parsing the video raw bit stream data of the sub-image.

The foregoing describes the video image presentation method and the video image encapsulation method in the embodiments of this application with reference to FIG. 1 to FIG. 10. The following describes a video image presentation apparatus and a video image encapsulation apparatus in the embodiments of this application with reference to FIG. 11 to FIG. 14. It should be understood that the presentation apparatus in FIG. 11 to FIG. 14 can implement the video image decoding method in FIG. 1 to FIG. 10, and the encapsulation apparatus can implement the video image encoding method in FIG. 1 to FIG. 10. For brevity, repeated descriptions are appropriately omitted below.

FIG. 11 is a schematic block diagram of a video image presentation apparatus according to an embodiment of this application. The apparatus 1100 includes:

an obtaining module 1110, configured to obtain a bit stream of a first video image;

a parsing module 1120, configured to parse the bit stream, and determine the first video image and first information of the first video image, where the first information is used to indicate whether the first video image is presented as a continuous area; and

a presentation module 1130, configured to present the first video image based on the first information.

Optionally, in an embodiment, the presentation module 1130 is specifically configured to present the first video image when the first information indicates that the first video image is presented as a continuous area.

Optionally, in an embodiment, at least a part of the first video image is adjacent to a second video image when the images are presented, and the presentation module 1130 is specifically configured to: when the first information indicates that the first video image is not presented as a continuous area, splice the first video image and the second video image based on a location relationship at which the images are presented and present the spliced image.

FIG. 12 is a schematic block diagram of a video image presentation apparatus according to an embodiment of this application. The apparatus 1200 includes:

an obtaining module 1210, configured to obtain a bit stream of a first video image;

a parsing module 1220, configured to parse the bit stream, and determine the first video image and second information of the first video image, where the second information is used to indicate an image type of the first video image, the image type includes a spherical image, a two-dimensional plane image not processed by using a first operation, or a two-dimensional plane image processed by using the first operation, and the first operation is at least one of segmentation, sampling, reversal, rotation, mirroring, or splicing; and

a presentation module 1230, configured to present the first video image based on the second information.

Optionally, in an embodiment, the presentation module 1230 is specifically configured to: when the second information indicates that the first video image is a spherical image, present the first video image in a spherical display manner.

Optionally, in an embodiment, the presentation module 1230 is specifically configured to: when the second information indicates that the first video image is a two-dimensional plane image not processed by using the first operation, map a sub-image as a spherical image; and present the spherical image in a spherical display manner.

Optionally, in an embodiment, the presentation module 1230 is specifically configured to: when the second information indicates that the first video image is the two-dimensional plane image processed by using the first operation, perform a second operation on the first video image to obtain a first video image processed by using the second operation, where the second operation is an inverse operation of the first operation; map the first video image processed by using the second operation as a spherical image; and present the spherical image in a spherical display manner.

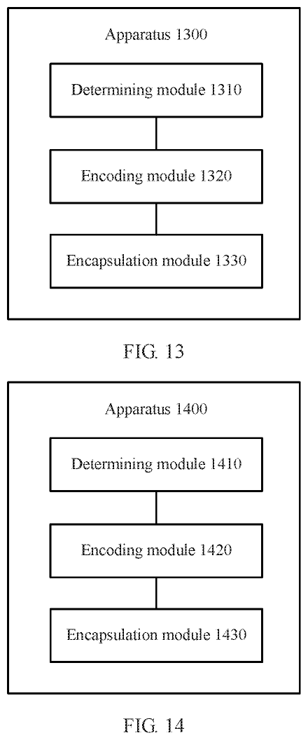

FIG. 13 is a schematic block diagram of a video image encapsulation apparatus according to an embodiment of this application. The apparatus 1300 includes:

a determining module 1310, configured to determine first information of a first video image, where the first information is used to indicate whether the first video image is a continuous area in a to-be-encoded image corresponding to the first video image;

an encoding module 1320, configured to encode the first video image and the first information to obtain a bit stream of the first video image; and

an encapsulation module 1330, configured to encapsulate the bit stream to obtain an image track of the first video image.

FIG. 14 is a schematic block diagram of a video image encapsulation apparatus according to an embodiment of this application. The apparatus 1400 includes:

a determining module 1410, configured to determine second information of a first video image, where the second information is used to indicate an image type of the first video image, the image type includes a spherical image, a two-dimensional plane image not processed by using a first operation, or a two-dimensional plane image processed by using the first operation, and the first operation is at least one of segmentation, sampling, reversal, rotation, mirroring, or splicing;

an encoding module 1420, configured to encode the first video image and the second information to obtain a bit stream of the first video image; and

an encapsulation module 1430, configured to encapsulate the bit stream to obtain an image track of the first video image.

It should be understood that the video image presentation method and the video image encapsulation method in this application may be performed by a codec apparatus or a system that includes a codec apparatus. In addition, the video image presentation apparatus and the video image encapsulation apparatus described above may also be specifically a codec apparatus or a codec system.

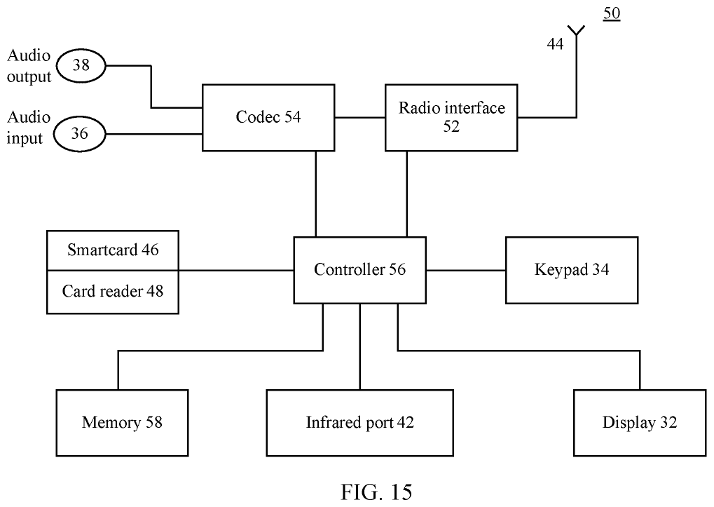

The following describes in detail, with reference to FIG. 15 to FIG. 17, a codec apparatus and a codec system that includes a codec apparatus. It should be understood that the codec apparatus and the codec system in FIG. 15 to FIG. 17 can perform the video image presentation method and the video image encapsulation method described above.

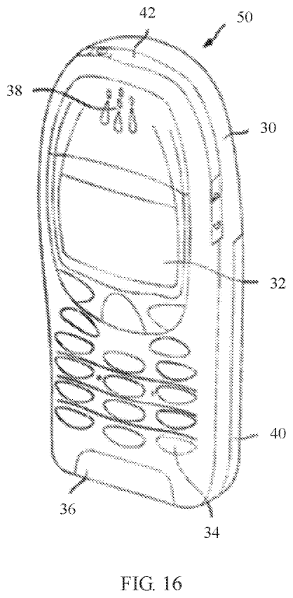

FIG. 15 and FIG. 16 show a codec apparatus 50 according to an embodiment of this application. The codec apparatus 50 may be a mobile terminal or user equipment of a wireless communications system. It should be understood that this embodiment of this application may be implemented in any electronic device or apparatus that may need to encode and/or decode a video image.

The codec apparatus 50 may include a housing 30 that is used to incorporate and protect a device, a display 32 (which may be specifically a liquid crystal display), and a keypad 34. The codec apparatus 50 may include a microphone 36 or any appropriate audio input, and the audio input may be digital or analog signal input. The codec apparatus 50 may further include the following audio output device, and in this embodiment of this application, the audio output device may be any one of an earphone 38, a loudspeaker, an analog audio output connection, or a digital audio output connection. The codec apparatus 50 may also include a battery 40. In other embodiments of this application, a device may be powered by any appropriate mobile energy device, such as a solar cell, a fuel cell, or a clock generator. The apparatus may further include an infrared port 42 used for short-range line-of-sight communication with another device. In other embodiments, the codec apparatus 50 may further include any appropriate short-range communication solution, such as a Bluetooth wireless connection or a USB wired connection.

The codec apparatus 50 may include a controller 56 or a processor that is configured to control the codec apparatus 50. The controller 56 may be connected to a memory 58. In this embodiment of this application, the memory may store image data or audio data, and/or store an instruction to be implemented on the controller 56. The controller 56 may be further connected to a codec 54 that is suitable for implementing audio and/or video data encoding and decoding, or for aided encoding and decoding that are implemented by the controller 56.

The codec apparatus 50 may further include a smartcard 46 and a card reader 48, such as a universal integrated circuit card (UICC) and a UICC reader, that are configured to provide user information and are suitable for providing authentication information used for network authentication and user authorization.

The codec apparatus 50 may further include a radio interface circuit 52. The radio interface circuit is connected to the controller and is suitable for generating, for example, a wireless communication signal used for communication with a cellular communications network, a wireless communications system, or a wireless local area network. The codec apparatus 50 may further include an antenna 44. The antenna is connected to the radio interface circuit 52, and is configured to send, to another apparatus (or a plurality of apparatuses), a radio frequency signal generated in the radio interface circuit 52, and receive a radio frequency signal from the another apparatus (or the plurality of apparatuses).

In some embodiments of this application, the codec apparatus 50 includes a camera capable of recording or detecting single frames, and the codec 54 or the controller receives and processes these single frames. In some embodiments of this application, the codec apparatus 50 may receive to-be-processed video image data from another device before transmission and/or storage. In some embodiments of this application, the codec apparatus 50 may receive, through a wireless or wired connection, an image to be encoded/decoded.

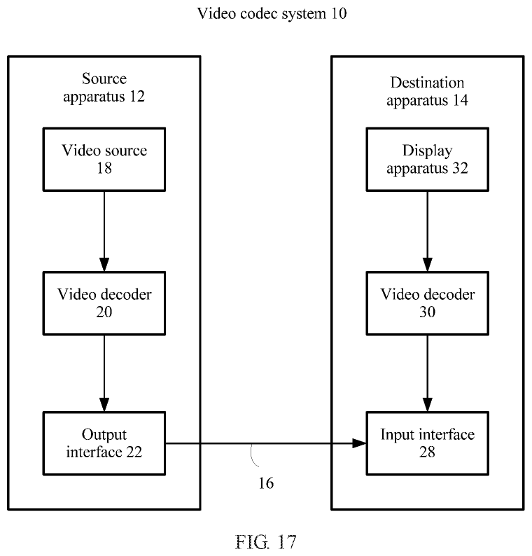

FIG. 17 is a schematic block diagram of a video codec system 10 according to an embodiment of this application. As shown in FIG. 17, the video codec system 10 includes a source apparatus 12 and a destination apparatus 14. The source apparatus 12 generates encoded video data. Therefore, the source apparatus 12 may be referred to as a video encoding apparatus or a video encoding device. The destination apparatus 14 may decode the encoded video data generated by the source apparatus 12. Therefore, the destination apparatus 14 may be referred to as a video decoding apparatus or a video decoding device. The source apparatus 12 and the destination apparatus 14 may be embodiments of a video codec apparatus or a video codec device. The source apparatus 12 and the destination apparatus 14 may include a desktop computer, a mobile computing apparatus, a notebook (for example, a laptop) computer, a tablet computer, a set top box, a handheld computer such as a smartphone, a television, a camera, a display apparatus, a digital media player, a video game console, an in-vehicle computer, or the like.

The destination apparatus 14 may receive the encoded video data from the source apparatus 12 through a channel 16. The channel 16 may include one or more media and/or apparatuses capable of moving the encoded video data from the source apparatus 12 to the destination apparatus 14. In an embodiment, the channel 16 may include one or more communications media that enable the source apparatus 12 to directly transmit the encoded video data to the destination apparatus 14 in real time. In this embodiment, the source apparatus 12 may modulate the encoded video data based on a communications standard (for example, a wireless communications protocol), and may transmit modulated video data to the destination apparatus 14. The one or more communications media may include a wireless and/or wired communications medium, such as a radio frequency (RF) spectrum or one or more physical transmission lines. The one or more communications media may constitute a part of a packet-based network (such as a local area network, a wide area network, or a global network (for example, the Internet)). The one or more communications media may include a router, a switch, a base station, or another device that facilitates communication between the source apparatus 12 and the destination apparatus 14.

In another embodiment, the channel 16 may include a storage medium that stores the encoded video data generated by the source apparatus 12. In this embodiment, the destination apparatus 14 may access the storage medium through disk access or card access. The storage medium may include a plurality of locally accessible data storage media, such as a Blu-ray, a DVD, a CD-ROM, a flash memory, or another appropriate digital storage medium configured to store encoded video data.

In another embodiment, the channel 16 may include a file server or another intermediate storage apparatus that stores the encoded video data generated by the source apparatus 12. In this embodiment, the destination apparatus 14 may access, through streaming transmission or downloading, the encoded video data stored on the file server or the another intermediate storage apparatus. The file server may be a type of server capable of storing the encoded video data and transmitting the encoded video data to the destination apparatus 14. For example, the file server may include a web server (for example, used for a website), a file transfer protocol (FTP) server, a network attached storage (NAS) apparatus, and a local disk drive.

The destination apparatus 14 may access the encoded video data through a standard data connection (for example, an Internet connection). Embodiment types of the data connection include a wireless channel (for example, a Wi-Fi connection) and a wired connection (for example, a DSL or a cable modem) that are suitable for accessing the encoded video data stored on the file server, or a combination thereof. The encoded video data may be transmitted from the file server through streaming transmission, download transmission, or a combination thereof

The encoding/decoding method of this application is not limited to a wireless application scenario. For example, the encoding/decoding method may be applied to video encoding and decoding that support a plurality of multimedia applications such as the following applications: over-the-air television broadcast, cable television transmission, satellite television transmission, streaming video transmission (for example, through the Internet), encoding of video data stored in a data storage medium, decoding of video data stored in a data storage medium, or another application. In some embodiments, the video codec system 10 may be configured to support unidirectional or bidirectional video transmission, so as to support applications such as video streaming transmission, video playing, video broadcast, and/or videotelephony.

In the embodiment of FIG. 17, the source apparatus 12 includes a video source 18, a video encoder 20, and an output interface 22. In some embodiments, the output interface 22 may include a modulator/demodulator (a modem) and/or a transmitter. The video source 18 may include a video capture apparatus (for example, a video camera), a video archive including previously captured video data, a video input interface configured to receive video data from a video content provider, and/or a computer graphic system configured to generate video data, or a combination of the foregoing video data sources.

The video encoder 20 may encode video data from the video source 18. In some embodiments, the source apparatus 12 directly transmits the encoded video data to the destination apparatus 14 by using the output interface 22. The encoded video data may alternatively be stored in the storage medium or on the file server, so that the destination apparatus 14 later accesses the encoded video data to be decoded and/or played.

In the embodiment of FIG. 17, the destination apparatus 14 includes an input interface 28, a video decoder 30, and a display apparatus 32. In some embodiments, the input interface 28 includes a receiver and/or a modem. The input interface 28 may receive the encoded video data through the channel 16. The display apparatus 32 may be integrated with the destination apparatus 14 or may be outside the destination apparatus 14. Usually, the display apparatus 32 displays decoded video data. The display apparatus 32 may include a plurality of types of display apparatuses, such as a liquid crystal display (LCD), a plasma display, an organic light-emitting diode (OLED) display, or another type of display apparatus.

The video encoder 20 and the video decoder 30 may perform operations according to a video compression standard (for example, the high efficiency video coding/decoding H.265 standard), and may conform to an HEVC test model (HM). The textual description ITU-TH.265 (V3) (04/2015) of the H.265 standard was released on Apr. 29, 2015, and may be downloaded from http://handle.itu.int/11.1002/1000/12455. All content of the document is incorporated by reference in its entirety.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A video image presentation method, comprising:
obtaining a bit stream of a first video image;
parsing the bit stream, and determining the first video image and first information of the first video image, wherein the first information is used to indicate whether the first video image is presented as a continuous area; and
presenting the first video image based on the first information.

2. The method according to claim 1, wherein the presenting the first video image based on the first information comprises:
presenting the first video image when the first information indicates that the first video image is presented as the continuous area.

3. The method according to claim 1, wherein at least a part of the first video image is adjacent to a second video image when the images are presented, and presenting a sub-image based on the first information comprises:
when the first information indicates that the first video image is not presented as the continuous area, splicing the first video image and the second video image into a spliced video image based on a location relationship at which the first and second images are presented and presenting the spliced video image.

4. A video image presentation method, comprising:
obtaining a bit stream of a first video image;
parsing the bit stream, and determining the first video image and information of the first video image, wherein the information is used to indicate an image type of the first video image, the image type of the first video image comprises a spherical image, a first two-dimensional plane image, or a second two-dimensional plane image processed by using a first operation and that is different from the first two-dimensional plane image, and the first operation is at least one of segmentation, sampling, reversal, rotation, mirroring, or splicing; and
presenting the first video image based on the information.

5. The method according to claim 4, wherein the presenting the first video image based on the information comprises:
presenting the first video image in a spherical display manner when the information indicates that the image type of the first video image is a spherical image.

6. The method according to claim 4, wherein the presenting the first video image based on the information comprises:
when the information indicates that the image type of the first video image is the first two-dimensional plane image, mapping the first video image as a spherical image; and
presenting the spherical image in a spherical display manner.

7. The method according to claim 4, wherein the presenting the first video image based on the information comprises:
when the information indicates that the first video image is the second two-dimensional plane image processed by using the first operation, performing a second operation on the first video image to obtain the first video image processed by using the second operation, wherein the second operation is an inverse operation of the first operation;
mapping the first video image processed by using the second operation as a spherical image; and
presenting the spherical image in a spherical display manner.

8. A video image presentation apparatus, comprising:
a non-transitory memory having processor-executable instructions stored thereon; and
a processor, coupled to the memory, configured to execute the processor-executable instructions to facilitate:
obtain a bit stream of a first video image;
parse the bit stream, and determine the first video image and first information of the first video image, wherein the first information is used to indicate whether the first video image is presented as a continuous area; and
present the first video image based on the first information.

9. The apparatus according to claim 8, wherein the processor is configured to execute the processor-executable instructions to facilitate:
present the first video image when the first information indicates that the first video image is presented as the continuous area.

10. The apparatus according to claim 8, wherein at least a part of the first video image is adjacent to a second video image when the images are presented, and the processor is configured to execute the processor-executable instructions to facilitate:
splice the first video image and the second video image into a spliced video image based on a location relationship at which the first and second images are presented and present the spliced video image, when the first information indicates that the first video image is not presented as a continuous area.

11. The method according to claim 4, wherein
the first two-dimensional plane image is not processed by the first operation.

12. The method according to claim 4, wherein
the second two-dimensional plane image is obtained by performing the first operation on the first two-dimensional plane image.

13. The method according to claim 4, wherein
the first two-dimensional plane image is obtained by mapping the spherical image to a plane; and
the second two-dimensional plane image is obtained by performing the first operation on the first two-dimensional plane image.

14. The method according to claim 4, wherein
the first two-dimensional plane image is obtained by mapping the spherical image to a hexahedron and then unfolding the six surfaces of the hexahedron.

15. The method according to claim 1, further comprising:
determining additional information of the first video image, wherein the additional information is used to indicate whether the first video image is a full-picture image; and
presenting the first video image based at least on the additional information and the first information.

16. The method according to claim 4, further comprising:
determining additional information of the first video image, wherein the additional information is used to indicate whether the first video image is a full-picture image; and
presenting the first video image based at least on the additional information and the information used to indicate the image type of the first video image.

17. The apparatus according to claim 8, wherein the processor is configured to execute the processor-executable instructions to facilitate:
determine additional information of the first video image, wherein the additional information is used to indicate whether the first video image is a full-picture image; and
present the first video image based at least on the additional information and the first information.

18. The method according to claim 7, wherein the first operation is packing, and the second operation is reverse packing.
